(19) United States
(12) Patent Application Publication
(10) Pub. No.: US 2005/0135970 A1
(43) Pub. Date: Jun. 23, 2005

(54) Hydrogen sulfide monitoring system

(76) Inventors: Shawn Alexander Mroczynski, Naughton (CA); Zbigniew Waszczylo, Skead (CA)

Correspondence Address: INCO PATENTS & LICENSING, PARK 80 WEST - PLAZA TWO, SADDLE BROOK, NJ, 07663, US

(21) Appl. No.: 10/740,002

(22) Filed: Dec. 18, 2003

(51) Int. Cl. B32B 5/02

(52) U.S. Cl. 422/86

(57) ABSTRACT

A system for measuring the quantity of hydrogen sulfide gas in a sulfur dioxide gaseous stream. A calorimeter is calibrated by a metered quantity of heated hydrogen sulfide calibration gas. A gas sample is grabbed from a source, generally a furnace, and a metered quantity is conditioned and introduced into a reaction cell. A probe in the reaction cell communicates with the calorimeter. The colorimeter measures the quantity of the hydrogen sulfide. A process logic controller monitors and operates the system and its internal and external components.

### TECHNICAL FIELD

This invention relates to the analysis of chemical compositions in general and, more particularly, to a system for measuring and analyzing the concentration of hydrogen sulfide (H₂S) in a sulfur dioxide (SO₂) environment or combinations of sulfur dioxide with water vapor/carbon monoxide/carbon dioxide/nitrogen/oxygen in a SO₂ environment.

### BACKGROUND OF THE INVENTION

Flash smelting sulfide ores generates large quantities of sulfur dioxide gas which is subsequently captured and treated. It often is converted into liquid SO₂ and sulfuric acid (H₂SO₄). However, due to the incomplete oxidation of the sulfur entrained in the ores, quantities of water (H₂O), and under the right conditions, considerable quantities of hydrogen sulfide gas may also be formed.

In the presence of SO₂, H₂S gas decomposes into elemental sulfur which adversely impacts plant equipment, plant performance and the eventual downstream quality of the liquid SO₂ and sulfuric acid by-products. Factors affecting the formation of the SO₂ gas include natural gas, coke quality and quantity, low oxygen (O₂) partial pressures, innate furnace design, feed quality, etc.

To help alleviate the undesirable formation of H₂S, roof mounted oxygen lances and downstream afterburners are installed in the flash furnaces to oxidize the resultant H₂S. Knowing the exact concentration of H₂S close to the source enables furnace operators to monitor and regulate the H₂S oxidizing equipment more efficiently by modulating the oxygen required to oxidize the H₂S.

At Inco Limited's Ontario Division (Copper Cliff, Ontario), oxygen lances were installed in the roof of a flash furnace to more fully oxidize the H₂S. In order to control the amount of oxygen injected into the furnace, an H₂S analyzer is required. Over-oxidizing, that is, using too much oxygen, results in various problems.

For example, in the furnace a shoulder buildup of oxides of feed concentrate in the uptake necessitates the furnace to be shut down for about six hours every two weeks so this material can be physically cleaned and removed. In addition, the production and routing of pure oxygen for various processes is costly, somewhat limited and requires close supervision. Better efficient modulation of the oxygen that is actually introduced into the lances can result in a substantial usage savings—up to 50%. For example, when the demand for oxygen exceeds the supply, the local extensive copper circuit is cut off resulting in lost productivity. By more closely monitoring and controlling the usage of oxygen, rather than excessively supplying it in a somewhat haphazard manner, additional precious pure oxygen is available for more pressing needs such as on-line metal production.

As far as the inventors are aware, there are no commercially available on-stream analyzers that are able to measure parts per million levels of H₂S in a 40-60% SO₂ gaseous environment. There are H₂S detectors/analyzers for use in paper mill stacks that use solid-state semiconductor technology or rotating tapes impregnated with lead acetate solutions. Unfortunately, these devices fail in the highly corrosive SO₂ environment.

As a result, furnace operators have used a somewhat crude manual stain test where the SO₂ gas is passed through a membrane impregnated with silver nitrate (AgNO₃). H₂S present in the gas forms a dark silver sulfide (Ag₂S) spot whose darkness level corresponds to the H₂S concentration in the gas. Experienced operators are able, with careful timing and control of the SO₂ gas flow, to roughly estimate the quantity of H₂S entrained in the SO₂ gas stream.

As noted above, this rough and ready measurement regimen leaves much to be desired. There is a need for a simple robust apparatus and method for accurately measuring the quantity of H₂S in a SO₂ gas stream.

### SUMMARY OF THE INVENTION

There is provided an automated H₂S stain test analyzer. A measured volume of sample process gas is introduced into a measured volume of AgNO₃ solution. The resulting color of the solution is analyzed by a colorimeter which subsequently provides a measurement reading to an operator and/or to a subsequent oxygen injection control device.

### BRIEF DESCRIPTION OF THE DRAWINGS

FIG. 1 is a schematic of an embodiment of the invention.

FIG. 2 is a graph depicting H₂S concentrations.

FIG. 3 is a graph depicting H₂S concentrations as a function of furnace conditions.

FIG. 4 is a graph depicting H₂S concentrations.

FIG. 5 is a graph depicting H₂S concentration as a function of furnace conditions.

### PREFERRED EMBODIMENTS OF THE INVENTION

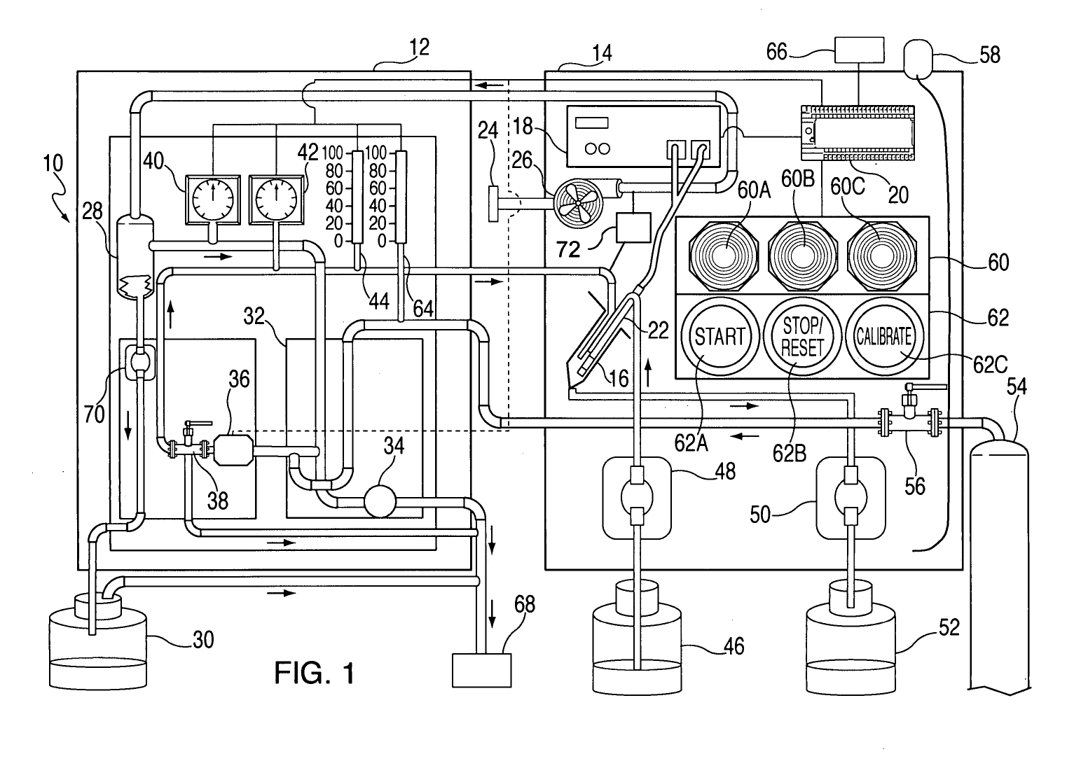

FIG. 1 is a schematic representation of the hydrogen sulfide monitoring system 10.

The system 10 is designed to operate with moisture in the sample process gas, typically up to about 100 ml/min continuous flow of H₂O(1) although the system 10 is not so limited, and under fluctuating vacuum levels. The system 10 operates continuously and provides an analysis, in parts per million (“ppm”), at selected periodic intervals. The read-out rate is adjustable but it is preferred to produce the ppm analysis every 2.5 minutes.

The system 10 includes a ganged sample conditioning system 12 and an H₂S analyzer section 14.

For ease of non-limiting discussion, the system 10 is arbitrarily divided into the sample conditioning system 12 and the hydrogen sulfide analyzer section 14. However, as will become evident in the following discussion, these arbitrary constructs are not meant to be physical limitations of the system 10. Various combinations of components may be arranged in different physical permutations.

The “heart” of the system 10 utilizes a reaction cell 16 communicating with a colorimeter 18. The colorimeter 18 in turn communicates and exchanges intelligence and instructions with an appropriately configured process logic controller (“PLC”) 20.

The colorimeter (or chromometer) 18 is an apparatus that measures the concentration of a selected component in a solution by comparing the colors of known concentrations in that solution.

In the embodiment shown the PLC 20 is an Allen Bradley Micrologix™ 1200 model and the colorimeter 18 is a Brinkmann™ PC 910 model. Naturally, similar components made by different or the same manufacturers may be used as well.

The basic chemical reaction that occurs in the reaction cell 16 is:
H₂S_{(GAS)}+2AgNO_{3(AQ)}→Ag₂S_{(PPT)}+2HNO^{3(AQ)}

The insoluble precipitated silver sulfide is so fine that it is uniformly distributed in the solution. The darkness of the solution (absorbance) is directly proportional to the hydrogen sulfide concentration.

The colorimeter 18 includes a two centimeter long probe 22 and a 420 nm filter (not shown).

Due to the desirably short sampling time of the system 10 and the high acidity of the AgNO₃ solution, the reaction cell 16 remains free of any Ag₂S or Ag₂SO₃ residue.

Process gas to be sampled from a furnace sample source port 24 is drawn by a gas pump 26 and routed to a gas filter/condenser 28. The gas filter/condenser 28 includes an internal impinger that draws the liquid out of the gas. Condensate is directed to a condensate sump 30. Trapped gases entrained therein will egress back to process for subsequent handling in drain 68.

Sample process gas emerges from the filter/condenser 28 and is heated by heater 32. A gas bypass waste gate 34 routes the sample process gas to the drain 68 or to a high precision gas flow control 36 (AEM Systems, Model 135, High Precision Sample Pressure [Flow] Controller) which meters the correct quantity of gas to the reaction cell 16 or to the drain 68. A solenoid valve 38 after the high precision flow control 36, switches gas flow between the reaction cell 16, and the drain 68 at timed intervals. Excess gas is sent to the drain 68 via the valve 34.

Gas flow parameters are measured by system pressure gauge 40 and sample pressure gauge 42. Flow rates and process calibrations are measured by detector 44 (AEM Systems, Model 136, Sample Flow Display with Low Flow Alarm Output). The detector 44, as well as all the other relevant components, are electrically connected to the PLC 20 for process operations and safety considerations in a manner known to those in the art. Some communication lines are shown as being solid, others are dashed and some are not shown for the sake of simplicity.

AgNO₃ solution is supplied to the reaction cell 16 from AgNO₃ source 46 via pump 48. Similarly, waste solution from the reaction cell 16 is drawn off by pump 50 and dumped into waste sump 52.

A source of 50 ppm H₂S gas for calibration purposes is stored in tank 54. The H₂S calibration gas is directed through the heater 32 and goes through the same path as the process gas. It passes through the high precision gas flow control 36 and into the reaction cell 16 via the solenoid valve 38. Process gas and excess H₂S gas are forced out by the waste gate 34 due to a pressure differential.

A valve 56 allows the H₂S gas to flow in a timed sequence (controlled from the PLC 20) when calibration button 62C is pressed. The H₂S gas then floods/purges the system to allow for calibration to occur. A flow detector 64 indicates the flow rate of the calibration gas from the tank 54.

A cooler 58 provides cooling for the analyzer 14's components and provides a positive pressure to keep dust out of the system enclosure (not shown). Cooler 58 cools the gas pump 26, AgNO₃ pump 48 and waste pump 50 as well as PLC 20, colorimeter 18, electronics, etc.

A series of color-coded warning and status lights 60 (60A, 60B, 60C) provide information to an operator.

Push button panel 62 (62A, 62B, 62C) allows the operator to start/run, stop and calibrate the system 10. Both the lights 60 and the panel 62 electrically communicate with the PLC 20.

The PLC 20 communicates with a monitor 66 and displays selected parameters. Indeed as noted previously all of the control components, valves, instruments and pumps are electrically connected to the PLC 20.

The operation of the system 10 is now discussed as follows:

Initially, the system 10 must be powered up and calibrated from a cold start.

The operator presses the start button 62A on the panel 62 and the sample conditioning module 12 electronics and heater 32 power up. The gas flow control 36 and the solenoid valve 38 receive power and the gas vacuum pump 26 starts. The sample-conditioning module 12 is now acquiring sample process gas from the source port 24 and conditioning it for the analyzer section 14 for analysis. While system 10 is powered up, pressing calibration button 62C puts the system 10 into calibration mode for one cycle (cycle=2.5 minutes) to allow calibration of flow rate to the reaction cell 16 to be set via a needle valve (not shown) for the gas flow controller 36.

Calibration Cycle:

1. The operator presses the calibrate button 62C and the associated calibration light 60C energizes indicating the calibration routine is now activated. Alternatively, this step, as well as most of the operations, may be automated.

2. The waste pump 50 starts and removes any waste solution that may be in the reaction cell 16.

3. The AgNO₃ solution pump 48 commences operation and fills the reaction cell 16 for about 25 seconds to produce a volume of about 4 mls in the cell 16. This covers the calorimeter probe 22.

4. The colorimeter 18 is energized and is ready to zero itself on the first bubble of calibration gas to ensure that there is zero drift in the readings. (The colorimeter 18 measures the absorbance of the solution in the reaction cell 16).
5. The colorimeter 18 takes about ten seconds to power up and zero itself so the calibration solenoid valve 56 is opened about three seconds before the colorimeter 18 zeros. The calibration gas from the tank 54 floods the entire system 12 and forces out the SO₂ process gas based on a pressure difference. The process gas runs between 5/psi (34.5 kPa) and 15/psi (103.4 kPa) and the calibration gas runs at a higher pressure than the greatest process gas pressure indicated on the system pressure gauge 40. This technique conforms to calibration standards.

6. The dry 50 ppm H₂S calibration gas (the remainder is nitrogen) is heated by the heater 32 and is introduced to the reaction cell 16 by the controller 36 and then by the solenoid valve 38 as the colorimeter 18 zeros itself. The gas flows into the cell 16 for about forty-four seconds and the high precision gas flow controller 36 that works on a differential pressure principle controls the flow.

7. After about forty-four seconds, the solenoid valve 38 stops the flow of gas to the reaction cell 16 and the signals representing concentration of H₂S in the cell 16 are captured by PLC 20, conditioned, then sent to a visual display such as a digital control system 66 where it is graphically displayed and the data logged for operators to see in the control room.

8. The waste pump 50 subsequently turns on and drains the cell 16 at which time the operator can decide whether or not to run the calibration routine again.

To adjust the calibration of the analyzer 14, the needle valve (not shown) is adjusted to control the pressure on the outlet of the gas flow controller 36. This changes the flow into the reaction cell 16, which changes the concentration of H₂S in the cell 16. The change in concentration is directly related to the absorbance by a linear relationship. The relationship between H₂S and absorbance is linear up to an absorbance of 0.800 A (representing 200 ppm H₂S).

The Process Gas Test Cycle:

The process gas test cycle is similar to the calibration cycle above except that the process gas sample from the furnace 24 flows to the reaction cell 16 (through essentially the same tubing as the calibration gas) instead of the calibration gas.

1. The waste pump 50 starts and removes any waste solution that may be in the reaction cell 16.

2. The AgNO₃ solution pump 48 starts and fills the reaction cell 16 for about twenty five seconds to produce a volume of about 4 mls in the cell 16. This covers the colorimeter probe 22.

3. The colorimeter 18 is energized and zeros itself on the first bubble of sample process gas to ensure that there is zero drift in the readings.

4. The process gas sample generally fluctuates between 5/psi (34.5 kPa) and 15 psi (103.4 kPa) coming into the sample conditioning system 12 and is continuous so that any particulate matter does not deposit in the tubing or any other analyzer parts. Moreover, keeping the gas flowing continuously allows the entire system to operate under steady-state conditions. If there is condensate in the gas, it will be forced out by the filter/condenser 28 (impinger design) along with most of the moisture, and up to about 100 ml/min liquid water. This separates the gas from any condensate, where the condensate is removed out at the bottom of the condenser 28, and the gas travels through the heater 32 and over to high precision gas flow control 36.

5. The process gas is heated by the heater 32 to keep any remaining moisture in the gas phase and is introduced to the reaction cell 16 by the valve 38 as the colorimeter 18 zeros itself. The gas flows into the cell for about forty-four seconds and the high precision gas flow controller 36 which works on a differential pressure principle controls the flow.

6. After about forty-four seconds, the solenoid 38 stops the flow of gas to the reaction cell 16 and the solution is allowed to reach equilibrium. Following equilibrium, the 4-20 mA signals generated by the probe 22 representing the ppm H₂S in the cell 16 are sent to the PLC 20 for signal conditioning and then to the display 66 to be graphically displayed and data logged for operators to see in the control room. This intelligence may be routed to an automatic oxygen injector control.

7. The waste pump 50 subsequently turns on and then drains the cell 16 and the cycle repeats at a relatively predetermined rate.

Experimental and actual operations testing demonstrated the efficacy of the system 10.

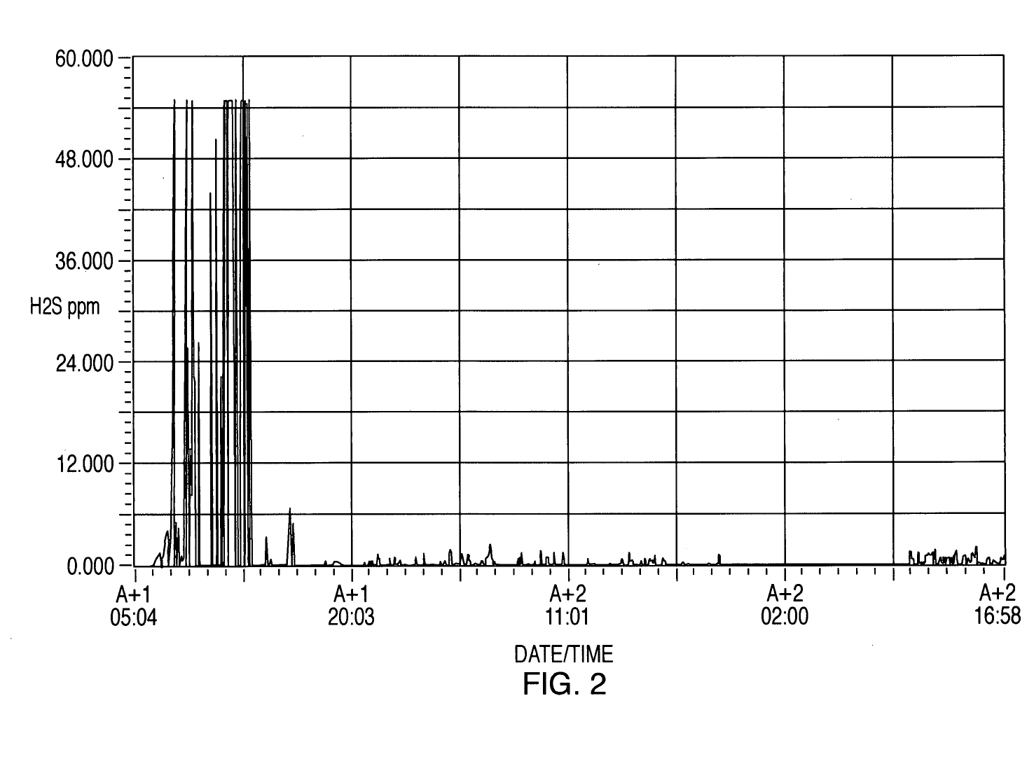

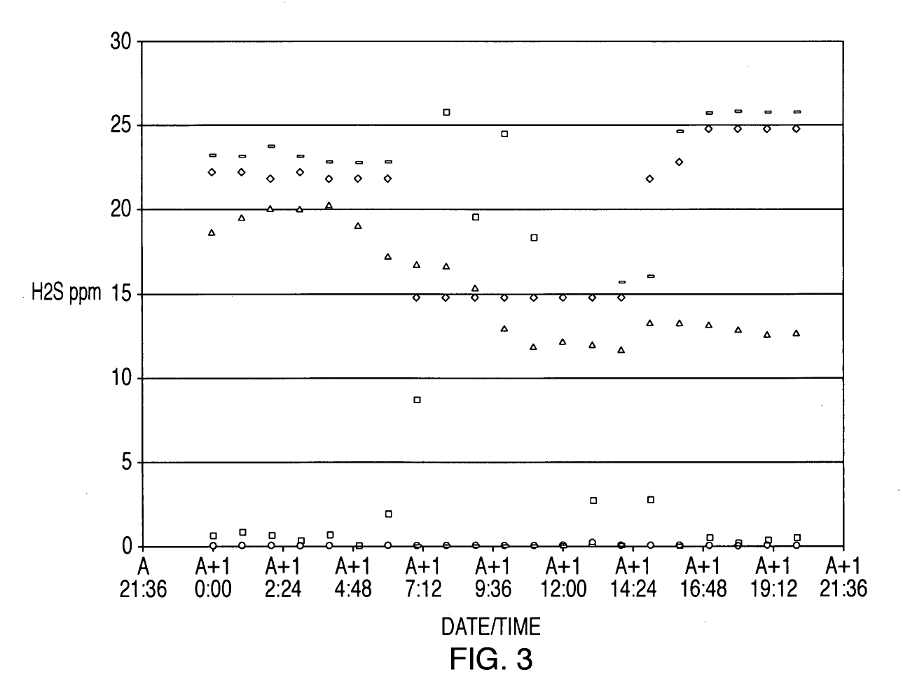

FIGS. 2 and 3 show H₂S data collected by the system 10 and the flash furnace conditions that contributed to the H₂S formation respectively. The data was collected over a sequential three-day period (day “A”, “A+1”, and “A+2”).

The vertical spikes in FIG. 2 indicate the presence of H₂S in the process gas stream sample. Each spike correlates and agrees with a simultaneous conventional “patch” test using paper impregnated with AgNO₃ placed in the process gas sample stream for a measured period of time and flow rate. The higher the spikes on the system 10 graph (FIG. 2), the darker the patch on the AgNO₃ paper.

FIG. 3 illustrates actual operating conditions (as does FIG. 2) in Inco Limited's Ontario Division Number 2 flash furnace during a two day (“A” and “A+1”) interval. The graph shows that the total oxygen to the afterburners and roof lances was zero. This caused a spike in the H₂S gas detected by the system 10. The deficiency in oxygen in the furnace uptake caused the H₂S gas to leave the furnace unoxidized. The furnace conditions support the system's 10 reading of H₂S gas.

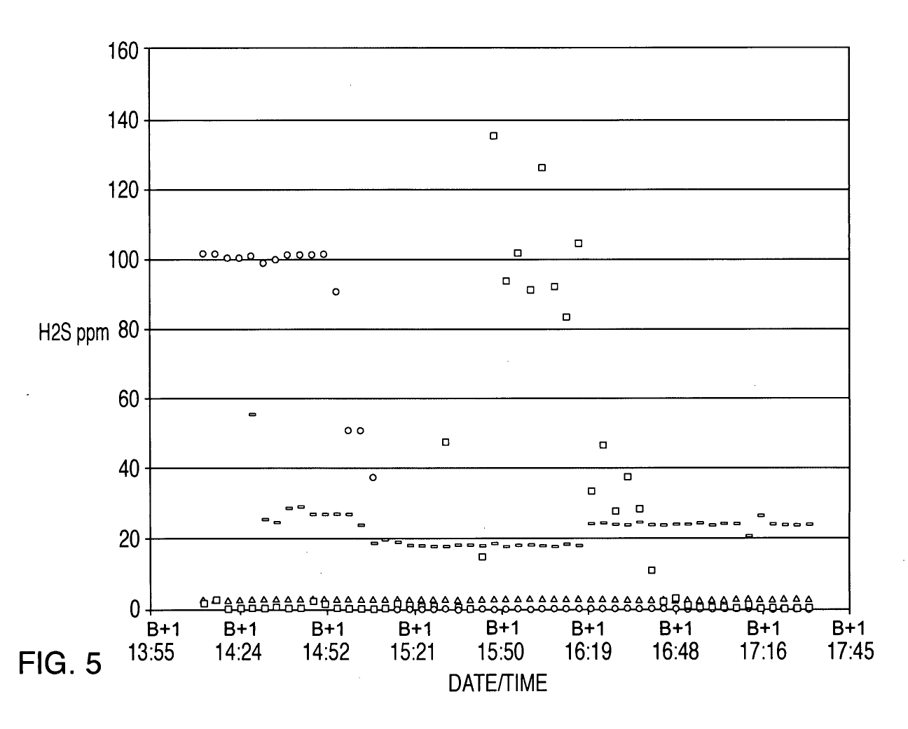

The following symbols shown in FIG. 3 (and FIG. 5) are defined as follows:
Δ signifies tonnes/hour of petroleum coke times 1000 (to fit in the graph)
◯ signifies natural gas/10 (to fit in the graph)
□ signifies filter plant H₂S readings as measured by the system 10 in parts per million.
⋄ signifies total tonnes/hours oxygen going into the furnace through two roof lances divided by tonnes/hour of dry solid charge (“DSC”) times 1000 (to fit in the graph).
▭ signifies total tonnes/hour of oxygen going into the furnace through two roof lances and four floor after burner business lances divided by tonnes/hour of DSC times 1000 (to fit in the graph).

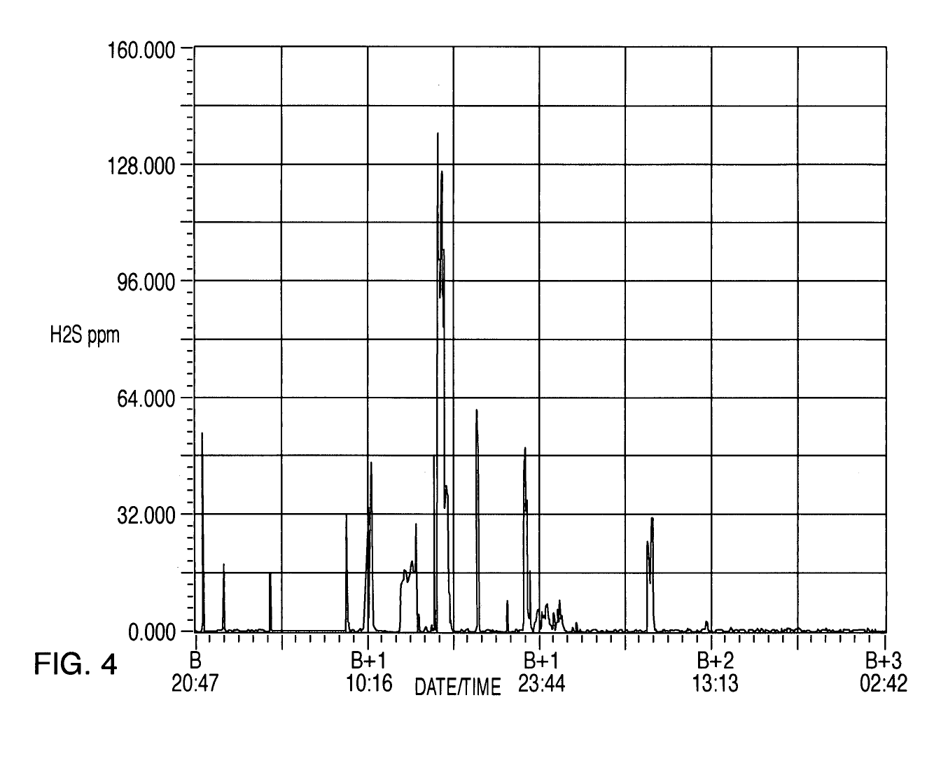

FIGS. 4 and 5 illustrate conditions in the flash furnace about a month later than those depicted in FIGS. 2 and 3. FIG. 4 depicts three consecutive days (B, B+1, B+2). The corresponding furnace operating conditions are shown in FIG. 5 during the single (second) day (“B+1”).

The data shown in FIG. 4 is the H₂S detected by the system 10. FIG. 5 indicates that the furnace decreased the total oxygen to the afterburners and lances and increased the amount of natural gas. This caused a spike in H₂S gas that corresponds to the detection by the system 10.

The FIGS. 2-5 demonstrate that the H₂S level in the process gas can be accurately monitored on an automatic continuous basis. The system 10 introduces efficiencies whereas the prior conventional detection process is a laborious manual batch technique.

The above discussion essentially relates to a wet basis analysis. Alternatively, the sample conditioning system 12 may be bypassed by bypass 72 in the event of a malfunction or maintenance. The bypass 72 includes a bypass (third) pump similar to the pumps 48 and 50 and drying crystals. The bypass pump draws a gas sample off the gas pump 26 and sends the sample through the drying crystals and then to the reaction cell 16.

This admittedly less desirable dry analysis bypass alternative provides a less accurate reading since the bypass pump does not deliver the same flow precision (measured volume) that the high precision gas flow control 36 does, especially under fluctuating vacuum conditions. Moreover, the drying crystals must be changed frequently when lots of water (condensate) is present in the gas. However, the system 10 and related technique are adaptable for continuous monitoring in a pinch.

While in accordance with the provisions of the statute, there is illustrated and described herein specific embodiments of the invention. Those skilled in the art will understand that changes may be made in the form of the invention covered by the claims and that certain features of the invention may sometimes be used to advantage without a corresponding use of the other features.

1. An automated system for monitoring hydrogen sulfide gas in a sulfur dioxide containing gas stream, the system comprising a gas sample conditioning system, an associated colorimeter-based hydrogen sulfide analyzer, and the system adapted to receive a sample of the sulfur dioxide containing gas stream.

2. The system according to claim 1 wherein the gas sample conditioning system includes a port for the sulfur dioxide containing gas sample to enter the gas sample conditioning system, a heater for heating the sulfur dioxide containing gas sample, a gas flow control disposed downstream-wise the heater for concisely regulating the gas sample stream flow to the hydrogen sulfide analyzer, and a wastegate to permit the gas sample stream flow to exit the sample conditioning system.

3. The system according to claim 2 wherein the gas sample conditioning system includes a gas condenser disposed between the heater and the port, and the condenser flowably connected to a condensate sump.

4. The system according to claim 2 including means for introducing a hydrogen sulfide calibration gas into the gas sample conditioning system upstream flow-wise the gas flow control.

5. The system according to claim 4 wherein the hydrogen sulfide calibration gas is routed through the heater.

6. The system according to claim 2 wherein the gas sample conditioning system includes a gas sample conditioning bypass connected to the port, the bypass including a bypass pump and drying crystals, and the bypass connected to the colorimeter-based hydrogen sulfide analyzer.

7. The system according to claim 1 wherein the colorimeter-based hydrogen sulfide analyzer section includes a reaction cell in gas flow communication with the sample conditioning system, a colorimeter connected to the reaction cell, and a waste solution sump connected to the reaction cell.

8. The system according to claim 1 including a process logic control communicating with the gas sample conditioning system and the colorimeter-based hydrogen sulfide analyzer and adapted to operate the system.

9. The system according to claim 8 including a control/status panel in communication with the process logic converter.

10. The system according to claim 7 including means for displaying the hydrogen sulfide content of the sulfur dioxide containing gas as measured by the system.

11. A process for measuring the quantity of hydrogen sulfide gas in a sulfur dioxide containing gas steam, the process comprising.
a) taking a sample of the sulfur dioxide containing gas;
b) regulating the temperature of the sample of the sulfur dioxide containing gas;
c) passing a metered sample of the sulfur dioxide containing gas to a reaction cell including a probe communicating with a calorimeter, the calorimeter calibratable by a source of known hydrogen sulfide calibration gas;
d) introducing a metered amount of silver nitrate solution into the reaction cell, and
e) causing the calorimeter to measure the quality of the hydrogen sulfide in the sample.

12. The process according to claim 11 including passing the sample of the sulfur dioxide containing gas through drying crystals prior to the reaction cell.
